(19) United States
(12) Patent Application Publication
(10) Pub. No.: US 2023/0348783 A1
(43) Pub. Date: Nov. 2, 2023

(54) METHOD OF MANUFACTURING LIGHT EMITTER, LIGHT EMITTER AND ULTRAVIOLET LIGHT SOURCE

(71) Applicant: HAMAMATSU PHOTONICS K.K., Hamamatsu-shi, Shizuoka (JP)

(72) Inventors: Kohei IKEDA, Hamamatsu-shi, Shizuoka (JP); Norio ICHIKAWA, Hamamatsu-shi, Shizuoka (JP)

(73) Assignee: HAMAMATSU PHOTONICS K.K., Hamamatsu-shi, Shizuoka (CN)

(21) Appl. No.: 18/025,709

(22) PCT Filed: Sep. 13, 2021
(86) PCT No.: PCT/JP2021/033519

§ 371 Date: Mar. 10, 2023

(30) Foreign Application Priority Data
Sep. 15, 2020 (JP) 2020-154494

(51) Int. Cl. C09K 11/77; C01B 25/37; H01J 63/06; H01J 61/44

(52) U.S. Cl. CPC C09K 11/7777; C01B 25/37; H01J 63/06; H01J 61/44; C01P 2002/54; C01P 2006/60; C01P 2002/72; C01P 2004/03

(57) ABSTRACT

The manufacturing method is a method for manufacturing a light emitter that generates ultraviolet light. The light emitter contains a YPO₄ crystal to which at least scandium (Sc) is added, and receives an electron beam or excitation light having a shorter wavelength than a wavelength of the ultraviolet light, to generate the ultraviolet light. The manufacturing method includes: producing a first mixture; producing a second mixture; producing a third mixture; and sintering the third mixture. The first mixture containing a compound of yttrium (Y), a compound of scandium (Sc), phosphoric acid or a phosphate compound, and a liquid is produced. In the producing the second mixture, the second mixture in a powder form is produced by evaporating the liquid. In the producing the third mixture, the third mixture is produced by mixing either one or both of an alkali metal halide and an alkali metal carbonate with the second mixture.

### TECHNICAL FIELD

The present disclosure relates to a method for manufacturing a light emitter, a light emitter, and an ultraviolet light source.

### BACKGROUND ART

Patent Literature 1 discloses an ultraviolet ray generation element. In the ultraviolet ray generation element, an ultraviolet ray is generated by excimer discharge means. The ultraviolet ray generation element includes a discharge tube. The discharge tube has a discharge space filled with a gas filler, and is at least partially transparent to the ultraviolet ray. Further, the ultraviolet ray generation element includes means for causing and maintaining excimer discharge in the discharge space, and a light-emitting material coating. The light-emitting material coating contains a phosphor having a host lattice expressed by a general equation (Y_{1-x-y-z}LuₓSc_{y}A_{z})PO₄. x, y, and z are values satisfying 0≤x<1, 0≤y<1, and 0<z<0.05. A is an activator and is selected from a group consisting of bismuth, praseodymium, and neodymium.

Patent Citation 2 discloses a method for manufacturing a phosphor. In this method, raw material powders of YPO₄:Bi are mixed to produce a mixed powder, and the mixed powder is sintered to synthesize YPO₄:Bi. In the mixing process, the raw material powders are mixed such that the concentration of Bi after mixing is 0.5 mol % or more and 2.0 mol % or less. In the sintering process, the mixed powder is sintered under the air atmosphere at 1400° C. or higher and 1700° C. or lower for a predetermined time.

Patent Literature 3 discloses an ultraviolet ray-emitting phosphor. The ultraviolet ray-emitting phosphor is expressed by a general equation (Lu, Y, Al)₁₋ₓPO₄:Scₓ. Here, x satisfies 0.005≤x≤0.80. The phosphor is excited by being irradiated with a vacuum ultraviolet ray or an electron beam, to emit an ultraviolet ray.

### CITATION LIST

### Patent Literature

Patent Literature 1: International Publication WO 2006/109238
Patent Literature 2: Japanese Unexamined Patent Publication No. 2017-165877
Patent Literature 3: International Publication WO 2018/235723

### SUMMARY OF INVENTION

### Technical Problem

An ultraviolet light source is known that has a structure in which a target is irradiated with an electron beam or excitation light to excite ultraviolet light. In addition, as a material of the target, a YPO₄ crystal to which at least Sc is added is known (refer to Patent Literatures 1 and 3). Such an ultraviolet light source requires a higher emission intensity of ultraviolet light.

An object of the present disclosure is to provide a method for manufacturing a light emitter, a light emitter, and an ultraviolet light source capable of increasing an emission intensity of ultraviolet light.

### Solution to Problem

According to one aspect of the present disclosure, there is provided a method for manufacturing a light emitter that generates ultraviolet light. The light emitter contains a YPO₄ crystal to which at least scandium (Sc) is added, and receives an electron beam or excitation light which has a shorter wavelength than a wavelength of the ultraviolet light, to generate the ultraviolet light. The manufacturing method includes: a step of producing a first mixture; a step of producing a second mixture; a step of producing a third mixture; and a step of sintering the third mixture. In the step of producing the first mixture, the first mixture containing a compound of yttrium (Y), a compound of scandium (Sc), phosphoric acid or a phosphate compound, and a liquid is produced. In the step of producing the second mixture, the second mixture in a powder form is produced by evaporating the liquid from the first mixture. In the step of producing the third mixture, the third mixture is produced by mixing either one or both of an alkali metal halide and an alkali metal carbonate (hereinafter, the alkali metal halide or the like) with the second mixture.

In the manufacturing method, the alkali metal halide or the like is mixed with the second mixture in a powder form containing a material for Sc:YPO₄ crystals, and then the mixture thereof is sintered. According to experiments carried out by the present inventors, the emission intensity of ultraviolet light can be increased by mixing the alkali metal halide or the like and by performing sintering. In the manufacturing method, the material for Sc:YPO₄ crystals is mixed with the liquid, the liquid is evaporated, and then the alkali metal halide or the like is mixed. Therefore, the alkali metal halide or the like (for example, LiF) is not used as a flux, and the alkali metal remains even after sintering.

In the manufacturing method according to one aspect of the present disclosure, the alkali metal halide may be at least one of LiF, NaF, and KF. According to experiments carried out by the present inventors, when as the alkali metal halide, particularly at least one of LiF, NaF, and KF is mixed with the second mixture, the emission intensity of ultraviolet light can be increased.

In the manufacturing method according to one aspect of the present disclosure, the alkali metal carbonate may be Li₂CO₃. According to experiments carried out by the present inventors, when as the alkali metal carbonate, particularly Li₂CO₃ is mixed with the second mixture, the emission intensity of ultraviolet light can be increased.

In the manufacturing method according to one aspect of the present disclosure, a concentration of the alkali metal halide in the third mixture before sintering may be 0.25% by mass or more and 1.0% by mass or less or 0.75% by mass or less. According to experiments carried out by the present inventors, when the concentration of the alkali metal halide is within this range, the emission intensity of ultraviolet light can be further increased.

In the manufacturing method according to one aspect of the present disclosure, a sintering temperature in the step of sintering the third mixture may be 1200° C. or higher. Alternatively, the sintering temperature may be 1400° C. or higher or 1600° C. or higher. The emission intensity of ultraviolet light can be increased by setting the sintering temperature to 1200° C. or higher. In addition, according to experiments carried out by the present inventors, when the sintering temperature is 1400° C. or higher or 1600° C. or higher, the emission intensity of ultraviolet light can be further increased.

According to one aspect of the present disclosure, there is provided a light emitter that generates ultraviolet light. The light emitter contains a YPO₄ crystal to which at least scandium (Sc) and an alkali metal are added, and receives an electron beam or excitation light which has a shorter wavelength than a wavelength of the ultraviolet light, to generate the ultraviolet light. As described above, the emission intensity of ultraviolet light can be increased by mixing the second mixture in a powder form containing a material for Sc:YPO₄ crystals with the alkali metal halide or the like, and by sintering the mixture. In addition, in the light emitter manufactured by such a manufacturing method, the alkali metal is contained significantly, in other words, as one component. Therefore, according to the light emitter, the emission intensity of ultraviolet light can be increased.

In the light emitter according to one aspect of the present disclosure, a half-value width of a diffraction intensity peak waveform of a <200> plane measured by an X-ray diffractometer using a CuKα ray may be 0.140 or less. According to experiments carried out by the present inventors, when the second mixture in a powder form is mixed with the alkali metal halide or the like, and the mixture is sintered, crystallinity can be improved, and a half-value width of a diffraction intensity peak waveform of a <200> plane can be, for example, such a small value. In addition, in this case, the emission intensity of ultraviolet light can be effectively increased.

In the light emitter according to one aspect of the present disclosure, the alkali metal may be at least one of Li, Na, and K. According to experiments carried out by the present inventors, when particularly at least one of LiF, NaF, and KF is mixed as the alkali metal halide, or when particularly Li₂CO₃ is mixed as the alkali metal carbonate, the emission intensity of ultraviolet light can be increased. In addition, in these cases, the light emitter contains at least one of Li, Na, and K as the alkali metal significantly, in other words, as one component.

An ultraviolet light source according to one aspect of the present disclosure includes: the light emitter; and a light source that irradiates the light emitter with the excitation light. An ultraviolet light source according to another aspect of the present disclosure includes: the light emitter; and an electron source that irradiates the light emitter with the electron beam. According to these ultraviolet light sources, the light emitter is provided, so that the emission intensity of ultraviolet light can be increased.

### Advantageous Effects of Invention

According to the present disclosure, it is possible to provide the method for manufacturing a light emitter, the light emitter, and the ultraviolet light source capable of increasing the emission intensity of ultraviolet light.

### BRIEF DESCRIPTION OF DRAWINGS

FIG. 1 is a schematic view showing an internal configuration of an electron-beam-excited ultraviolet light source of according to one embodiment.

FIG. 2 is a cross-sectional view showing a configuration of an ultraviolet light generation target.

FIG. 3 is a cross-sectional view showing a configuration of a photoexcited ultraviolet light source.

FIG. 4 is a cross-sectional view of the ultraviolet light source shown in FIG. 3 taken along line IV-IV.

FIG. 5 is a cross-sectional view showing a configuration of another photoexcited ultraviolet light source.

FIG. 6 is a cross-sectional view of the ultraviolet light source shown in FIG. 5 taken along line VI-VI.

FIG. 7 is a cross-sectional view showing a configuration of another photoexcited ultraviolet light source.

FIG. 8 is a cross-sectional view of the ultraviolet light source shown in FIG. 7 taken along line VIII-VIII.

FIG. 9 is a flowchart showing each step in a method for manufacturing a light emitter.

FIG. 10 is a flowchart showing each step in a method for manufacturing a light emitter using laser ablation.

FIG. 11 is a view schematically showing an experimental apparatus used in examples.

FIG. 12 is a graph showing PL intensity spectra of ultraviolet light obtained from experiments.

FIG. 13 is a graph showing a relationship between the concentration of LiF in a third mixture containing LiF and the PL peak intensity of ultraviolet light obtained from a sample obtained by sintering the third mixture.

FIG. 14 is a graph showing an X-ray diffraction pattern of each sample.

FIG. 15 is a polygonal line graph including two lines. One line shows a relationship between weight percentage concentration of LiF in the third mixture and half-value width of a (200) plane PL peak near 26 degrees of an X-ray diffraction pattern in the sample obtained by sintering the third mixture at a sintering temperature of 1600° C. The other line shows a relationship between weight percentage concentration of LiF in the third mixture and PL peak intensity in the same sample.

FIG. 16 is a table showing the half-value widths of the (200) plane PL peaks and actual measured values of the PL peak intensities shown in FIG. 15.

FIG. 17 is a table showing results of ICP atomic emission spectroscopy (ICP-AES) performed to check an amount of Li contained in Sc:YPO₄ crystals after sintering.

FIG. 18 is a view showing an SEM photograph of powder surfaces of a sample produced according to an example.

FIG. 19 is a view showing an SEM photograph of powder surfaces of a sample produced according to an example.

FIG. 20 is a view showing an SEM photograph of powder surfaces of a sample produced according to an example.

FIG. 21 is a view showing an SEM photograph of powder surfaces of a sample produced according to an example.

FIG. 22 is a view showing an SEM photograph of powder surfaces of a sample produced according to an example.

FIG. 23 is a view showing an SEM photograph of powder surfaces of a sample produced according to an example.

FIG. 24 is a polygonal line graph including two lines. One line shows a relationship between mass percentage concentration of LiF in the third mixture and true density (unit: g/cm³) of crystals in the sample obtained by sintering the third mixture at a sintering temperature of 1600° C. The other line shows a relationship between weight percentage concentration of LiF in the third mixture and specific surface area (unit: m²/g) in the same sample.

FIG. 25 is a table showing values of the true density and the specific surface area shown in FIG. 24.

FIG. 26 is a view conceptually showing true densities and specific surface areas in Sc:YPO₄ crystals obtained by sintering a mixture not containing LiF or the like and in Sc:YPO₄ crystals obtained by sintering a mixture containing LiF.

### DESCRIPTION OF EMBODIMENTS

Specific examples of a method for manufacturing a light emitter, a light emitter, and an ultraviolet light source of the present disclosure will be described below with reference to the drawings. The present invention is not limited to these examples. The present invention is indicated by the claims, and it is intended to include all changes within the meaning and the scope equivalent to the claims. In the following description, the same reference numerals will be applied to the same elements in description of the drawings, and redundant description thereof will be omitted.

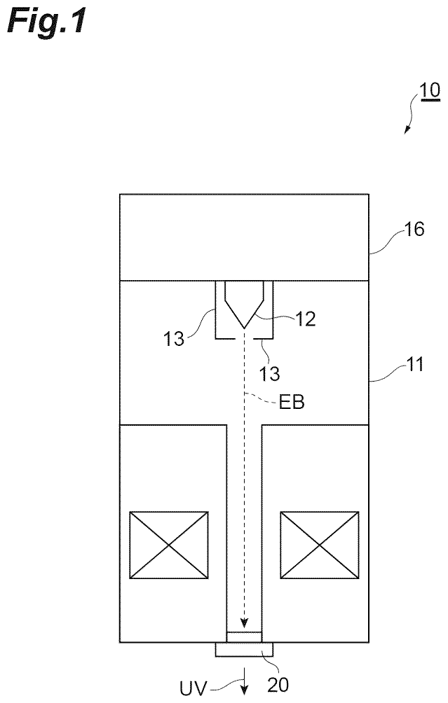

FIG. 1 is a schematic view showing an internal configuration of an electron-beam-excited ultraviolet light source 10 according to one embodiment. As shown in FIG. 1, in the ultraviolet light source 10, an electron source 12 and an extraction electrode 13 are disposed on an upper end side inside an envelope 11 as an evacuated electron tub. In addition, when a proper extraction voltage is applied between the electron source 12 and the extraction electrode 13 from a power supply unit 16, an electron beam EB accelerated by a high voltage is emitted from the electron source 12. For example, an electron source that emits a large-area electron beam is used as the electron source 12. The electron source that emits a large-area electron beam is, for example, a cold cathode such as a carbon nanotube, or a hot cathode.

In addition, an ultraviolet light generation target 20 is disposed on a lower end side inside the envelope 11. The ultraviolet light generation target 20 is set to, for example, a ground potential, and a negative high voltage is applied to the electron source 12 from the power supply unit 16. Accordingly, the ultraviolet light generation target 20 is irradiated with the electron beam EB emitted from the electron source 12. The ultraviolet light generation target 20 receives the electron beam EB to be excited and generates ultraviolet light UV.

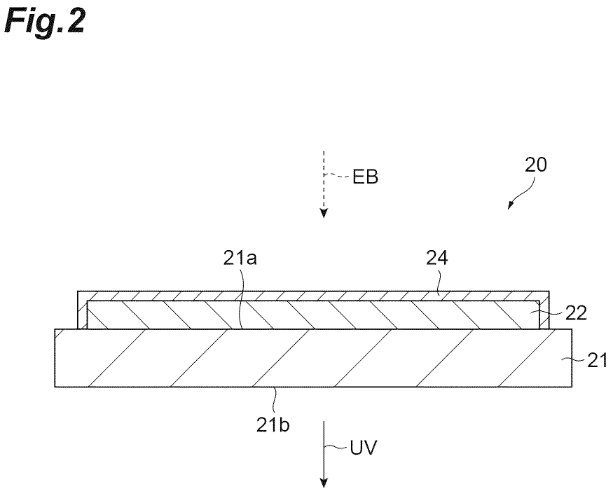

FIG. 2 is a cross-sectional view showing a configuration of the ultraviolet light generation target 20. As shown in FIG. 2, the ultraviolet light generation target 20 includes a substrate 21; a layered light emitter 22 provided on the substrate 21; and a light reflection film 24 provided on the light emitter 22. The substrate 21 is a plate-shaped member made of a material that transmits the ultraviolet light UV, and is made of sapphire (Al₂O₃) in the present embodiment. The substrate 21 has a main surface 21a and a back surface 21b. A thickness of the substrate 21 is, for example, 0.1 mm or more and 10 mm or less.

The light emitter 22 is in contact with the main surface 21a of the substrate 21, and receives the electron beam EB to be excited and generate the ultraviolet light UV. The light emitter 22 contains an oxide crystal which contains a rare earth element and to which an activator and an alkali metal are added.

In the present embodiment, the activator is scandium (Sc). In addition to Sc, other elements such as bismuth (Bi) may be added as activators. The alkali metal is, for example, at least one of Li, Na, and K. The oxide crystal containing a rare earth element is an oxide of yttrium (Y) and phosphorus (P), namely, YPO₄ (yttrium phosphate). In one example, a composition of the light emitter 22 can be expressed as (ScₓY₁₋ₓ)A_{y}PO₄ (0<x<1 and 0<y<1). A is the alkali metal (Li, Na, or K). A film thickness of the light emitter 22 is, for example, 0.1 μm or more and 1 mm or less.

The degree of crystallization of the light emitter 22 changes according to sintering temperature. As shown in examples to be described later, a half-value width of a diffraction intensity peak waveform of a <200> plane of the light emitter 22 measured by an X-ray diffractometer (X-ray diffraction: XRD) using a CuKα ray (wavelength: 1.54 Å) may be 0.140° or less.

The light reflection film 24 contains, for example, a metal material such as aluminum. The light reflection film 24 completely covers an upper surface and side surfaces of the light emitter 22. Of the ultraviolet light UV generated in the light emitter 22, light traveling in a direction opposite the substrate 21 is reflected by the light reflection film 24, and travels toward the substrate 21.

In the ultraviolet light generation target 20, when the electron beam EB emitted from the electron source 12 (refer to FIG. 1) is incident on the light emitter 22, the light emitter 22 is excited and the ultraviolet light UV is generated. Some of the ultraviolet light UV travels directly toward the main surface 21a of the substrate 21. The remaining portion of the ultraviolet light UV is reflected by the light reflection film 24, and then travels toward the main surface 21a of the substrate 21. Thereafter, the ultraviolet light UV is incident on the main surface 21a, is transmitted through the substrate 21, and then is radiated to the outside from the back surface 21b.

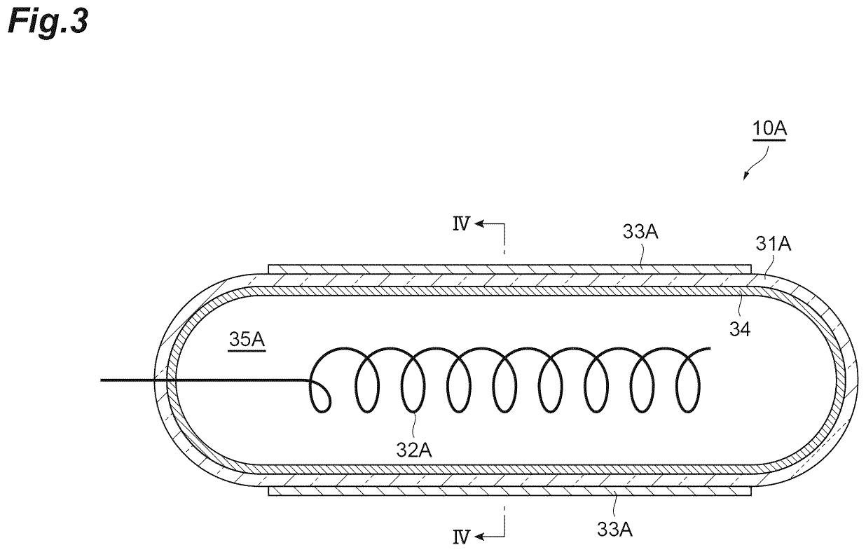

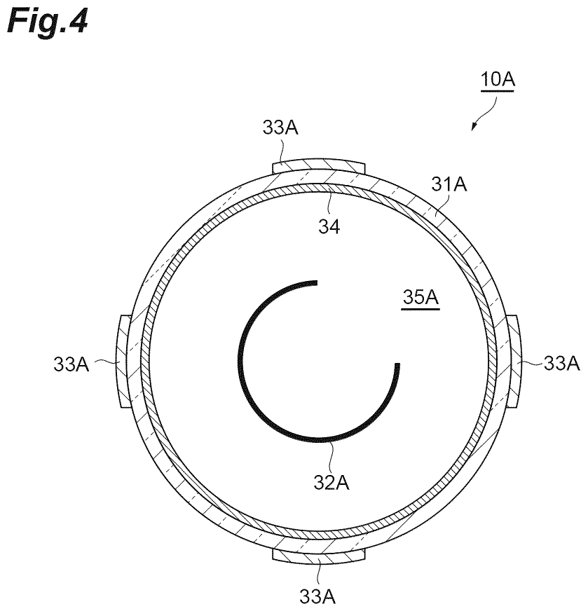

FIG. 3 is a cross-sectional view showing a configuration of a photoexcited ultraviolet light source 10A, and shows a cross section including a central axis. FIG. 4 is a cross-sectional view of the ultraviolet light source 10A shown in FIG. 3 taken along line IV-IV, and shows a cross section perpendicular to the central axis. As shown in FIGS. 3 and 4, the ultraviolet light source 10A includes an envelope 31A that is evacuated; an electrode 32A disposed inside the envelope 31A; a plurality of electrodes 33A disposed outside the envelope 31A; and a light emitter 34 that is disposed on an inner surface of the envelope 31A to generate ultraviolet light.

The envelope 31A has a substantially cylindrical shape. One end and the other end of the envelope 31A in a central axis direction are closed in a hemispherical shape, and an internal space 35A of the envelope 31A is airtightly sealed. A forming material of the envelope 31A is, for example, quartz glass. The forming material of the envelope 31A is not limited to quartz glass as long as the forming material is a material that transmits ultraviolet light output from the light emitter 34. The internal space 35A is filled with, for example, xenon (Xe) as discharge gas.

The electrode 32A is, for example, a metal filament, and is introduced into the internal space 35A from the outside of the envelope 31A. In the example shown in FIGS. 3 and 4, the electrode 32A is bent in a spiral shape, and extends from a position close to the one end of the envelope 31A to a position close to the other end in the internal space 35A. As shown in FIG. 4, the electrode 32A is disposed at a center of the internal space 35A in a cross section perpendicular to the central axis of the envelope 31A. Each of the electrodes 33A is, for example, a metal film that is in close contact with an outer wall surface of the envelope 31A. In the example shown in FIGS. 3 and 4, four electrodes 33A are provided. The four electrodes 33A each extend along the central axis direction of the envelope 31A, and are arranged at equal intervals in a circumferential direction of the envelope 31A.

A high-frequency voltage is applied between the electrode 32A and the electrodes 33A. Accordingly, a discharge plasma is formed in a space between the electrode 32A and the electrodes 33A, namely, in the internal space 35A of the envelope 31A. As described above, since the internal space 35A is filled with the discharge gas, when the discharge plasma is generated, the discharge gas performs excimer light emission to generate vacuum ultraviolet light. When the discharge gas is Xe, a wavelength of the generated vacuum ultraviolet light is 172 nm.

The light emitter 34 is disposed in a film shape over an entire inner wall surface of the envelope 31A. The light emitter 34 has the same composition as that of the light emitter 22 of the ultraviolet light source 10 described above. The light emitter 34 is excited by the vacuum ultraviolet light generated in the internal space 35A as excitation light, to generate ultraviolet light having, for example, a wavelength of 241 nm longer than the wavelength of the vacuum ultraviolet light. The ultraviolet light generated from the light emitter 34 is transmitted through the envelope 31A, and is output to the outside of the envelope 31A from gaps between the plurality of electrodes 33A. Namely, the electrode 32A, the electrodes 33A, and the discharge gas in the internal space 35A form a light source for irradiating the light emitter 34 with excitation light having, for example, a first wavelength of 172 nm. Then, the light emitter 34 receives the excitation light having the first wavelength, and generates ultraviolet light having, for example, a second wavelength of 241 nm longer than the first wavelength. A film thickness of the light emitter 34 is, for example, 0.1 μm or more and 1 mm or less.

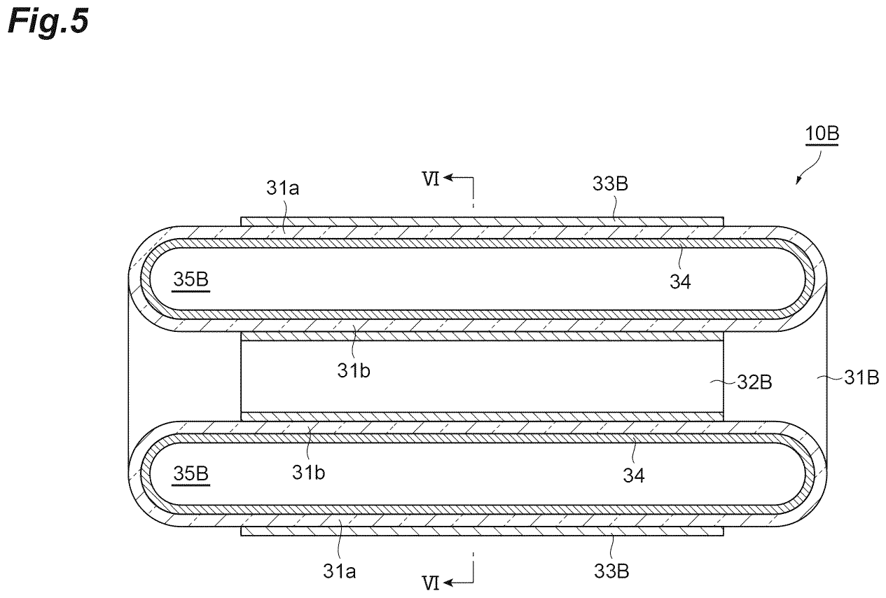

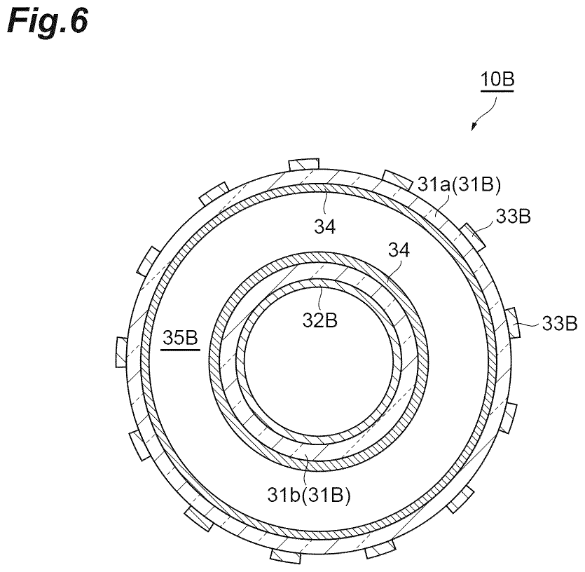

FIG. 5 is a cross-sectional view showing a configuration of another photoexcited ultraviolet light source 10B, and shows a cross section including a central axis. FIG. 6 is a cross-sectional view of the ultraviolet light source 10B shown in FIG. 5 taken along line VI-VI, and shows a cross section perpendicular to the central axis. As shown in FIGS. 5 and 6, the ultraviolet light source 10B includes an envelope 31B, an electrode 32B, a plurality of electrodes 33B, and the light emitter 34. The main difference between the ultraviolet light source 10B and the ultraviolet light source 10A described above is shapes of the envelope 31B and the electrode 32B.

The envelope 31B of the ultraviolet light source 10B has a double cylindrical shape, and includes an outer cylindrical portion 31a and an inner cylindrical portion 31b. A gap between the inner cylindrical portion 31b and the outer cylindrical portion 31a is closed at both ends of the envelope 31B in a central axis direction, and forms an internal space 35B that is airtightly sealed. Other configurations of the envelope 31B are the same as those of the envelope 31A. The electrode 32B is disposed inside the inner cylindrical portion 31b. For example, the electrode 32B is a metal film formed on an inner wall surface of the inner cylindrical portion 31b. The electrode 32B extends from a position close to one end of the inner cylindrical portion 31b to a position close to the other end in the central axis direction. Each of the electrodes 33B is, for example, a metal film that is in close contact with an outer wall surface of the outer cylindrical portion 31a. In the example shown in FIGS. 5 and 6, 13 electrodes 33B are provided. The plurality of electrodes 33B each extend along the central axis direction of the envelope 31B, and are arranged at equal intervals in a circumferential direction of the outer cylindrical portion 31a.

A high-frequency voltage is applied between the electrode 32B and the electrodes 33B. Accordingly, a discharge plasma is formed in a space between the electrode 32B and the electrodes 33B, namely, in the internal space 35B of the envelope 31B. Since the internal space 35B is filled with a discharge gas, when the discharge plasma is generated, the discharge gas performs excimer light emission to generate vacuum ultraviolet light. The light emitter 34 is disposed in a film shape over an entire inner wall surface of the envelope 31B. The light emitter 34 is excited by the vacuum ultraviolet light generated in the internal space 35B as excitation light, to generate ultraviolet light having a wavelength longer than a wavelength of the vacuum ultraviolet light. The ultraviolet light generated from the light emitter 34 is transmitted through the envelope 31B, and is output to the outside of the envelope 31B from gaps between the plurality of electrodes 33B. Namely, the electrode 32B, the electrodes 33B, and the discharge gas in the internal space 35B form a light source for irradiating the light emitter 34 with excitation light having the first wavelength. Then, the light emitter 34 receives the excitation light having the first wavelength, and generates ultraviolet light having the second wavelength longer than the first wavelength.

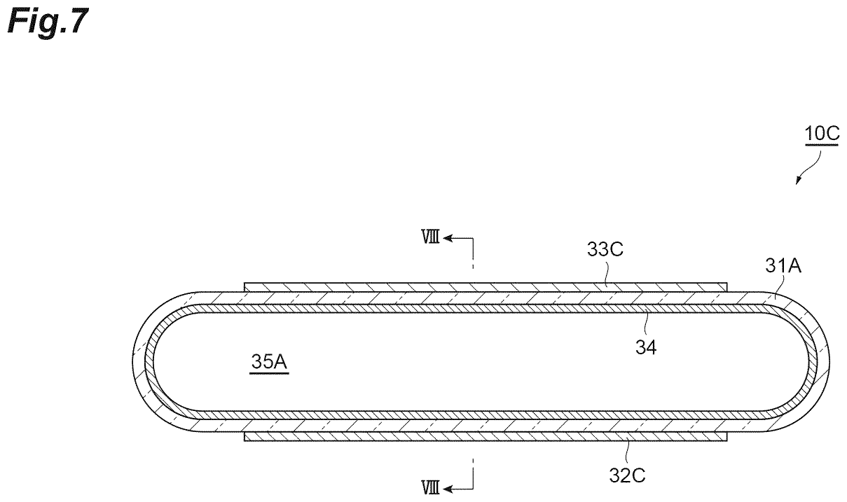

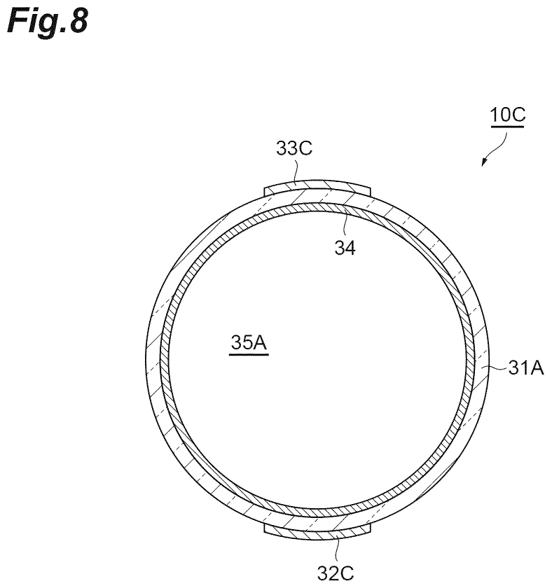

FIG. 7 is a cross-sectional view showing a configuration of another photoexcited ultraviolet light source 10C, and shows a cross section including a central axis. FIG. 8 is a cross-sectional view of the ultraviolet light source 10C shown in FIG. 7 taken along line VIII-VIII, and shows a cross section perpendicular to the central axis. As shown in FIGS. 7 and 8, the ultraviolet light source 10C includes the envelope 31A, an electrode 32C, an electrode 33C, and the light emitter 34. The main difference between the ultraviolet light source 10C and the ultraviolet light source 10A described above is a mode of the electrodes 32C and 33C.

The electrodes 32C and 33C of the ultraviolet light source 10C are disposed outside the envelope 31A having a cylindrical shape. In one example, each of the electrodes 32C and 33C is a metal film formed on the outer wall surface of the envelope 31A. The electrode 33C is disposed on the outer wall surface of the envelope 31A at a position where the electrode 33C faces the electrode 32C with the central axis interposed therebetween. The electrodes 32C and 33C extend along a central axis direction.

A high-frequency voltage is applied between the electrode 32C and the electrode 33C. Accordingly, a discharge plasma is formed in a space between the electrode 32C and the electrode 33C, namely, in the internal space 35A of the envelope 31A. Since the internal space 35A is filled with the discharge gas, when the discharge plasma is generated, the discharge gas performs excimer light emission to generate vacuum ultraviolet light. The light emitter 34 is excited by the vacuum ultraviolet light generated in the internal space 35A as excitation light, to generate ultraviolet light having a wavelength longer than a wavelength of the vacuum ultraviolet light. The ultraviolet light generated from the light emitter 34 is transmitted through the envelope 31A, and is output to the outside of the envelope 31A from a gap between the electrodes 32C and 33C. Namely, the electrode 32C, the electrode 33C, and the discharge gas in the internal space 35A form a light source for irradiating the light emitter 34 with excitation light having the first wavelength.

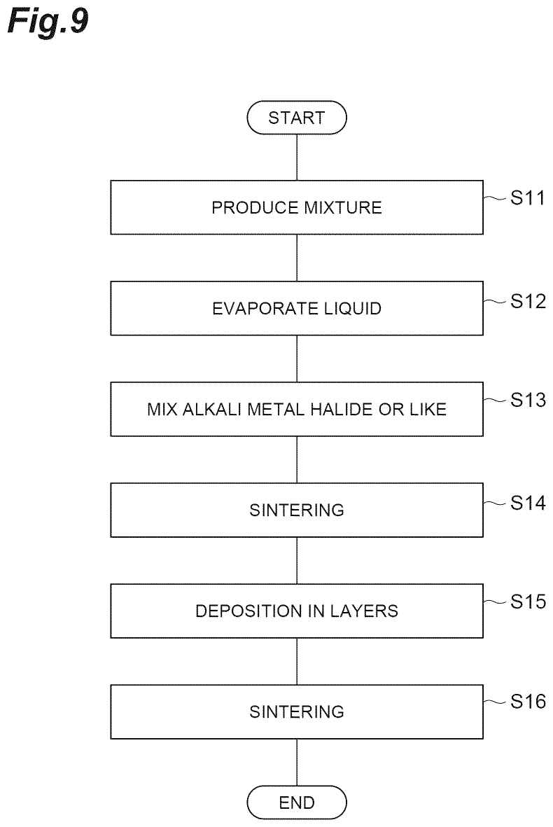

FIG. 9 is a flowchart showing each step in a method for manufacturing the light emitters 22 and 34. First, in step S11, a first mixture containing a compound of Y (in one example, an oxide of Y (Y₂O₃)), a compound of Sc (in one example, an oxide of Sc (Sc₂O₃)), phosphoric acid (H₃PO₄) or a phosphate compound (for example, ammonium dihydrogen phosphate (NH₄H₂PO₄)), and a liquid (for example, pure water) is produced. At this time, a compound of Bi (in one example, an oxide of Bi (Bi₂O₃)) may be further added to the first mixture. Specifically, a compound of Y, a compound of Sc, and phosphoric acid are put into the liquid contained in a container, and stirring is sufficiently performed. The time required for stirring is, for example, 24 hours. Accordingly, the phosphoric acid and each compound react each other and are matured in the container.

Next, in step S12, the first mixture is heated to evaporate the liquid. Accordingly, a second mixture in a powder form obtained by removing the liquid from the first mixture is produced. In one example, the temperature of a heater is within a range of 100° C. to 300° C., and an actual solution temperature is within a range of 70° C. to 90° C. The heating time is within a range of 1 hour to 5 hours.

Subsequently, in step S13, a third mixture is produced by mixing either one or both of an alkali metal halide and an alkali metal carbonate (hereinafter, referred to as an alkali metal halide or the like) with the second mixture. In one example, the alkali metal halide or the like and a small amount of ethanol are added to the second mixture, and the mixture is put into an agate mortar and is wet-mixed.

In step S13, the concentration of the alkali metal halide in the third mixture excluding the ethanol is set to, for example, 0.25% by mass or more and 1.0% by mass or less or 0.75% by mass or less. In one example, the alkali metal halide is at least one of alkali metal fluorides, for example, LiF, NaF, and KF. In addition, in one example, the alkali metal carbonate is Li₂CO₃.

Subsequently, in step S14, sintering, namely, heat treatment is performed on the third mixture. Specifically, first, the third mixture put in a crucible is installed in, for example, a heat treatment furnace such as an electric furnace. Then, by heat treatment is performed on the third mixture in the air, the third mixture is sintered. Accordingly, the forming material of the third mixture is crystallized. The sintering temperature at this time may be, for example, 1200° C. or higher, 1400° C. or higher, or 1600° C. or higher. In a temperature range of 1600° C. or lower, the higher the sintering temperature is, the higher the degree of crystallization of the light emitters 22 and 34 is, so that the emission intensity of the ultraviolet light UV can be increased. An upper limit of the sintering temperature is, for example, 1700° C. The sintering time is, for example, two hours.

Subsequently, in step S15, in the case of the light emitter 22, crystals in a powder form after sintering are disposed in layers on the substrate 21. Alternatively, in the case of the light emitter 34, crystals in a powder form after sintering are disposed in layers on the inner wall surface of the envelope 31A or 31B. At this time, the crystals in a powder form may be placed on the substrate 21 or on the inner wall surface of the envelope 31A or 31B as they are, but a sedimentation method may be used. The sedimentation method is a method in which the crystals in a powder form are put into a liquid such as alcohol, the crystals are dispersed in the liquid using an ultrasonic wave or the like, and then the crystals are naturally settled on the substrate 21 or on the inner wall surface of the envelope 31A or 31B disposed at a lower portion of the liquid, and are dried. The crystals can be deposited with a uniform density and thickness on the substrate 21 or on the inner wall surface of the envelope 31A or 31B by using such a method. In such a manner, the light emitter 22 is formed on the substrate 21, or the light emitter 34 is formed on the inner wall surface of the envelope 31A or 31B.

Subsequently, in step S16, sintering, namely, heat treatment may be performed on the light emitters 22 and 34 again. The sintering is performed in the air for the purpose of sufficiently evaporating the alcohol and for the purpose of increasing adhesion between the substrate 21 or the envelope 31A or 31B and the crystals and adhesion between the crystals. The sintering temperature at the time is, for example, 1100° C. The sintering time is, for example, two hours.

The light emitters 22 and 34 of the present embodiment are completed through the above steps. When the ultraviolet light generation target 20 is produced, after the above steps, the light reflection film 24 is formed to cover the upper surface and the side surfaces of the light emitter 22. A method for forming the light reflection film 24 is, for example, vacuum evaporation. A thickness of the light reflection film 24 on the upper surface of the light emitter 22 is, for example, 50 nm.

In the above description, after the sintering of the third mixture, the crystals are deposited on the substrate 21 or on the inner wall surface of the envelope 31A or 31B, but the third mixture before sintering may be deposited on the substrate 21 or on the inner wall surface of the envelope 31A or 31B, and then sintering may be performed on the third mixture. In that case, the deposition of the third mixture on the substrate 21 or on the inner wall surface of the envelope 31A or 31B may be performed by the above-described sedimentation method. Alternatively, after organic matter as a binder is mixed with the third mixture, and the mixture is applied to the substrate 21 or to the inner wall surface of the envelope 31A or 31B, the third mixture may be sintered to remove the organic matter.

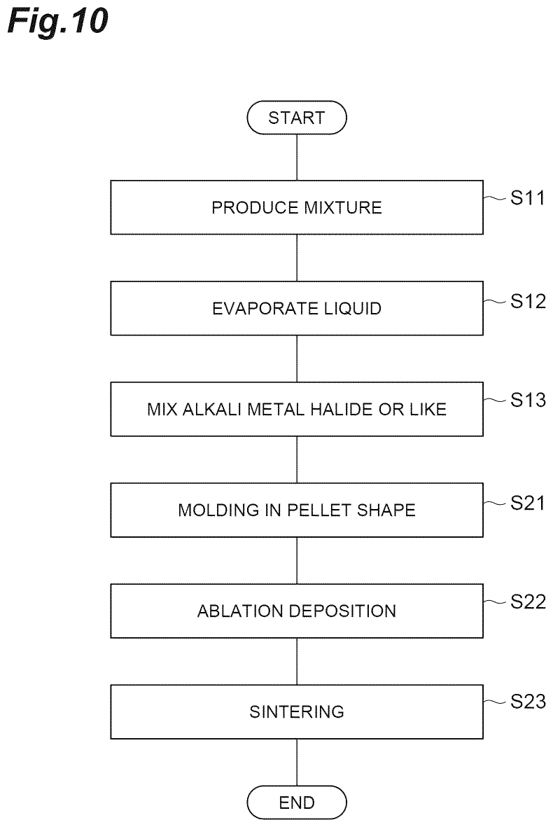

Alternatively, the third mixture may be deposited on the substrate 21 by laser ablation. FIG. 10 is a flowchart showing each step in a method for manufacturing the light emitter 22 using laser ablation. Incidentally, since steps S11 to S13 are the same as those described above, the detailed description thereof will not be repeated.

In step S21 after step S13, the third mixture is molded in a pellet shape to produce a target. Next, in step S22, the substrate 21 is installed on a rotary holder of a laser ablation device, and the produced target is placed on a sample placement table. Then, the inside of a vacuum container is evacuated, and the substrate 21 is heated to, for example, a predetermined temperature of 800° C. by a heater.

Thereafter, while oxygen gas is supplied to the inside of the vacuum container from a gas introduction inlet, a laser beam is introduced from a laser introduction inlet, and the target is irradiated with the laser beam. The laser beam is, for example, a laser beam having a wavelength of 248 nm from a KrF excimer laser. The raw material forming the target receives the laser beam to evaporate and scatter inside the vacuum container. Some of the scattered raw materials adhere to an exposed one surface of the substrate 21. Accordingly, an amorphous layer of Sc:YPO₄ containing an alkali metal is formed on the one surface of the substrate 21. This method is called an ablation deposition method. In such a manner, Sc:YPO₄ containing an alkali metal is disposed in layers on the substrate 21.

Subsequently, in step S23, the amorphous layer of Sc:YPO₄ containing an alkali metal formed on the one surface of the substrate 21 is sintered. Specifically, the substrate 21 on which the amorphous layer is formed is extracted from the laser ablation device, and is put into a sintering device. Then, the amorphous layer on the substrate 21 is sintered by setting the temperature of the sintering device to, for example, 1200° C. or higher, 1400° C. or higher, or 1600° C. or higher, and by maintaining the temperature for a predetermined time. Accordingly, the light emitter 22 is formed on the one surface of the substrate 21. The sintering atmosphere is, for example, vacuum or air. The sintering time is, for example, within a range of 1 hour to 10 hours.

Effects obtained by the light emitters 22 and 34, the manufacturing method thereof, and the ultraviolet light sources 10 and 10A to 10C in the present embodiment described above will be described.

In the manufacturing method of the present embodiment, the alkali metal halide or the like is mixed with the second mixture in a powder form containing a material for Sc:YPO₄ crystals, and then the mixture is sintered. According to experiments carried out by the present inventors, the emission intensity of ultraviolet light can be increased by mixing the alkali metal halide or the like and by performing sintering. In the manufacturing method, the material for Sc:YPO₄ crystals is mixed with the liquid, the liquid is evaporated, and then the alkali metal halide or the like is mixed. Therefore, the alkali metal halide or the like (for example, LiF) is not used as a flux, and the alkali metal remains even after sintering.

In the case of mixing an alkali metal carbonate with the second mixture, unlike an alkali metal fluoride such as LiF, NaF, or KF, even when the alkali metal carbonate decomposes during sintering, HF that is toxic and corrosive is not generated, which is an advantage.

As described above, the alkali metal halide may be at least one of LiF, NaF, and KF. According to experiments carried out by the present inventors, when as the alkali metal halide, particularly at least one of LiF, NaF, and KF is mixed with the second mixture, the emission intensity of ultraviolet light can be increased.

As described above, the alkali metal carbonate may be Li₂CO₃. According to experiments carried out by the present inventors, when as the alkali metal carbonate, particularly Li₂CO₃ is mixed with the second mixture, the emission intensity of ultraviolet light can be increased.

As described above, the concentration of the alkali metal halide in the third mixture before sintering excluding ethanol for wet-mixing may be set to 0.25% by mass or more and 1.0% by mass or less or 0.75% by mass or less. According to experiments carried out by the present inventors, when the concentration of the alkali metal halide is within this range, the emission intensity of ultraviolet light can be further increased.

As described above, the sintering temperature in steps S16 and S23 of sintering the third mixture may be 1200° C. or higher. Alternatively, the sintering temperature may be 1400° C. or higher or 1600° C. or higher. When the sintering temperature is 1200° C. or higher, the emission intensity of ultraviolet light can be increased. In addition, according to experiments carried out by the present inventors, when the sintering temperature is 1400° C. or higher or 1600° C. or higher, the emission intensity of ultraviolet light can be further increased.

The light emitters 22 and 34 of the present embodiment contain YPO₄ crystals to which Sc as an activator and an alkali metal are added. As described above, the emission intensity of ultraviolet light can be increased by mixing the second mixture in a powder form containing a material for Sc:YPO₄ crystals with the alkali metal halide or the like, and by sintering the mixture. In addition, in the light emitters 22 and 34 manufactured by such a manufacturing method, the alkali metal is contained significantly, in other words, as one component. Therefore, according to the light emitters 22 and 34, the emission intensity of ultraviolet light can be increased.

In the light emitters 22 and 34 of the present embodiment, the half-value width of the diffraction intensity peak waveform of the <200> plane measured by the X-ray diffractometer using a CuKα ray may be 0.140 or less. According to experiments carried out by the present inventors, when the second mixture in a powder form is mixed with the alkali metal halide or the like, and the mixture is sintered, crystallinity can be improved, and a half-value width of a diffraction intensity peak waveform of a <200> plane can be, for example, such a small value. In addition, in this case, the emission intensity of ultraviolet light can be effectively increased.

As described above, the alkali metal may be at least one of Li, Na, and K. According to experiments carried out by the present inventors, when particularly at least one of LiF, NaF, and KF is mixed as the alkali metal halide, or when particularly Li₂CO₃ is mixed as the alkali metal carbonate, the emission intensity of ultraviolet light can be increased. In addition, in these cases, the light emitter contains at least one of Li, Na, and K as the alkali metal significantly, in other words, as one component.

The ultraviolet light sources 10 and 10A to 10C of the present embodiment include the light emitter 22 or the light emitter 34. Accordingly, it is possible to provide the ultraviolet light source in which the emission intensity of ultraviolet light is increased.

### Examples

Here, examples of the embodiment will be described. The present inventors actually produced samples of Sc:YPO₄ containing a plurality of alkali metals, as the light emitter 22 or 34, by a method described below.

First, Y₂O₃, Sc₂O₃, and H₃PO₄ were mixed with pure water to produce a plurality of first mixtures. Specifically, Y₂O₃, Sc₂₀₃, H₃PO₄, and the pure water were put into a beaker, and were sufficiently stirred in room temperature for 24 hours. At this time, the amount of Y₂O₃, the amount of Sc₂O₃, the amount of H₃PO₄, and the amount of the pure water were set to 7.846 g, 0.252 g, 5.1 ml, and 900 ml, respectively, such that the concentration of Sc and the concentration of Y in components of each sample excluding P and O were 5 mol % and 95 mol %, respectively. Accordingly, the plurality of first mixtures were obtained. Thereafter, while stirring was continued, heating was performed to evaporate the pure water from the plurality of first mixtures. Accordingly, a plurality of second mixtures in a powder form were obtained.

0.00238 g, namely, 0.25% by mass of LiF and 10 ml of ethanol were added to 0.95003 g of powder of the second mixture produced by a liquid-phase method, and the mixture was put into an agate mortar and was wet-mixed. Accordingly, a third mixture (1) containing LiF was obtained. In addition, 0.00365 g, namely, 0.8% by mass of NaF and 10 ml of ethanol were added to 0.44906 g of powder of the second mixture, and the mixture was put into an agate mortar and was wet-mixed. Accordingly, a third mixture (2) containing NaF was obtained. In addition, 0.00541 g, namely, 1.1% by mass of KF and 10 ml of ethanol were added to 0.48299 g of powder of the second mixture, and the mixture was put into an agate mortar and was wet-mixed. Accordingly, a third mixture (3) containing KF was obtained. In addition, 0.00144 g, namely, 0.71% by mass of Li₂CO₃ and 10 ml of ethanol were added to 0.20068 g of powder of the second mixture, and the mixture was put into an agate mortar and was wet-mixed. Accordingly, a third mixture (4) containing Li₂CO₃ was obtained.

Thereafter, the third mixtures (1) to (4) and the second mixtures were installed inside an electric furnace in the air atmosphere, and were sintered at 1600° C. for two hours. In addition, a plurality of the third mixtures (1) having different concentrations of LiF were produced and sintered for two hours with three types of sintering temperatures of 1200° C., 1400° C., and 1600° C. set for each concentration. The sintered crystals in a powder form were sieved to select crystals having a grain size of 20 μm or less. The selected crystals were deposited on a quartz substrate by the sedimentation method. After deposition, sintering was performed at 1100° C. for two hours in the air atmosphere. The sintered samples were irradiated with light from a xenon excimer lamp having a wavelength of 172 nm to evaluate ultraviolet rays emitted from the excited samples.

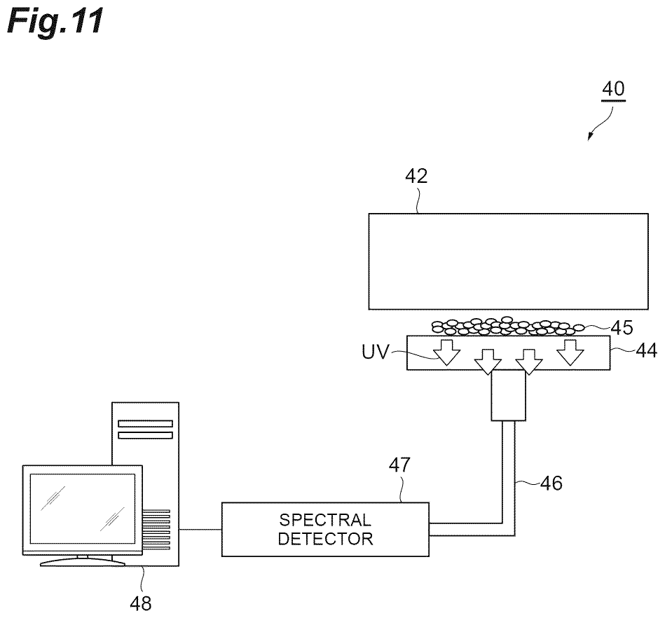

FIG. 11 is a view schematically showing an experimental apparatus used in the present examples. A device 40 includes an ultraviolet light source 42 disposed to face a sample 45 on a quartz substrate 44. The ultraviolet light source 42 is an excimer lamp in which a glass envelope is filled with Xe as discharge gas. An emission wavelength of the ultraviolet light source 42 was 172 nm. The sample 45 on the quartz substrate 44 was irradiated with ultraviolet light from the ultraviolet light source 42. One end of an optical fiber 46 faced a back surface of the quartz substrate 44, namely, a surface opposite a surface on which the sample 45 was disposed. The other end of the optical fiber 46 was connected to a spectral detector 47. As the spectral detector 47, Photonic Multi-Analyzer PMA-12, model number C10027-01, manufactured by HAMAMATSU PHOTONICS K.K. was used. Of the ultraviolet light UV that the sample 45 generated by being excited by ultraviolet light, the ultraviolet light UV that was transmitted through the quartz substrate 44 was taken into the spectral detector 47 via the optical fiber 46, and was analyzed by a computer 48 connected to the spectral detector 47.

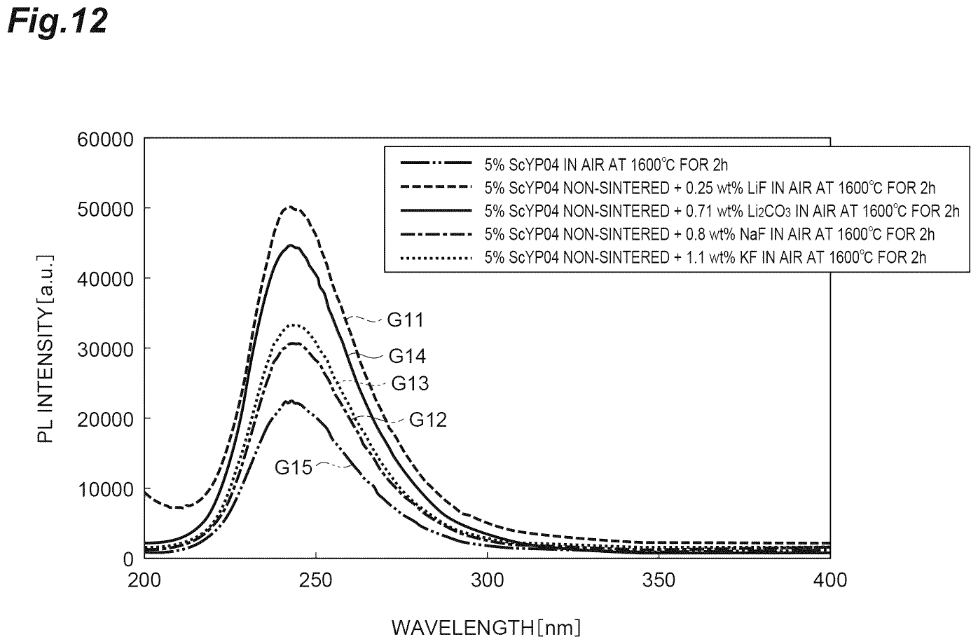

FIG. 12 is a graph showing photoluminescence (PL) intensity spectra of the ultraviolet light UV obtained by the above experiments. In the graph, the vertical axis represents light intensity (arbitrary unit), and the horizontal axis represents wavelength (unit: nm). A curved line G11 shows a PL intensity spectrum of the sample obtained by sintering the third mixture (1) containing LiF. A curved line G12 shows a PL intensity spectrum of the sample obtained by sintering the third mixture (2) containing NaF. A curved line G13 shows a PL intensity spectrum of the sample obtained by sintering the third mixture (3) containing KF. A curved line G14 shows a PL intensity spectrum of the sample obtained by sintering the third mixture (4) containing Li₂CO₃. A curved line G15 shows a PL intensity spectrum of the sample obtained by sintering the second mixture in which none of LiF, NaF, KF, and Li₂CO₃ is mixed.

The PL peak wavelength of the sample (refer to the curved line G15) obtained by sintering the second mixture was around 240 nm, and was 243 nm in this experiment. In addition, as shown in FIG. 12, the PL peak wavelength of each of the samples (refer to the curved lines G11 to G14) obtained by sintering the third mixtures (1) to (4) hardly changed from the PL peak wavelength (refer to the curved line G15) of the sample obtained by sintering the second mixture. However, the PL peak intensity of each of the samples obtained by sintering the third mixtures (1) to (4) increased remarkably from the PL peak intensity of the sample obtained by sintering the second mixture. An increase in the PL peak intensity of the sample obtained by sintering the third mixture (1) containing LiF and of the sample obtained by sintering the third mixture (4) containing Li₂CO₃ was particularly remarkable. Incidentally, when an alkali metal halide other than LiF, NaF, and KF and an alkali metal carbonate other than Li₂CO₃ are mixed with the second mixture, similarly, it is expected that the PL peak intensity increases.

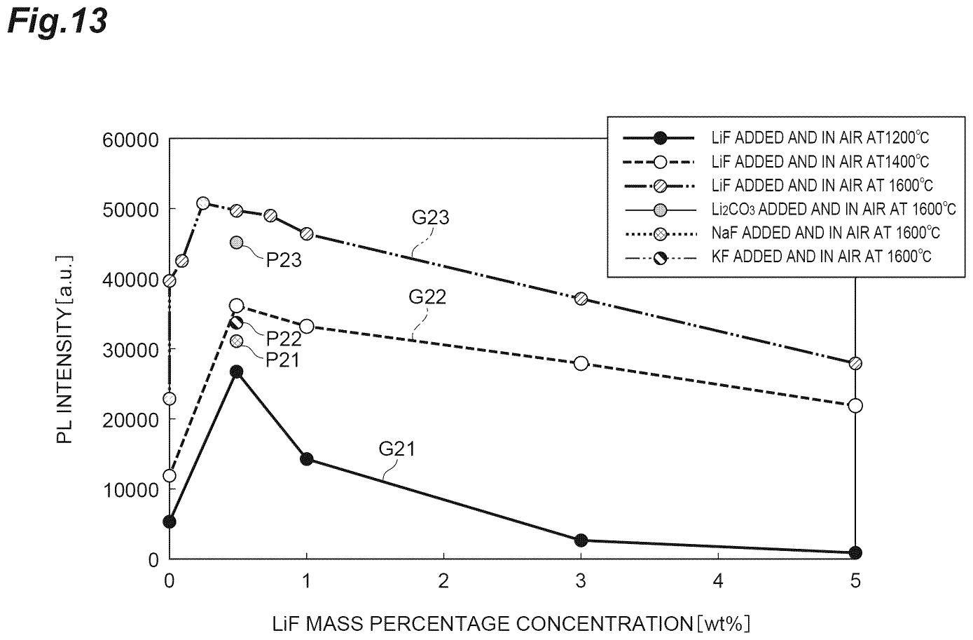

FIG. 13 is a graph showing a relationship between the concentration of LiF in the third mixture (1) containing LiF and the PL peak intensity of the ultraviolet light UV obtained from the sample obtained by sintering the third mixture (1). In the graph, the vertical axis represents PL peak intensity (arbitrary unit), and the horizontal axis represents mass percentage concentration of LiF. A line G21 shows the case of a sintering temperature of 1200° C. A line G22 shows the case of a sintering temperature of 1400° C. A line G23 shows the case of a sintering temperature of 1600° C. For comparison, the PL peak intensities of the sample obtained by sintering the third mixture (2) containing NaF, the sample obtained by sintering the third mixture (3) containing KF, and the sample obtained by sintering the third mixture (4) containing Li₂CO₃ are shown by plots P21 to P23, respectively.

As shown in FIG. 13, when the third mixtures containing LiF were sintered, the PL peak intensity in the case of a sintering temperature of 1200° C. was the lowest, and the PL peak intensity in the case of a sintering temperature of 1600° C. was the highest. When the sintering temperature was 1600° C. and the concentration of LiF in the third mixture was 0.25% by mass to 0.75% by mass, namely, 0.017 mol to 0.053 mol, the PL peak intensity was the highest. The PL peak intensity when the concentration of LiF was 1.0% by mass or less was higher than the PL peak intensity when the concentration of LiF was higher than 1.0% by mass. The PL peak intensity of the sample which was obtained at a sintering temperature of 1600° C. and in which the concentration of LiF in the third mixture was 0.25% by mass was improved to 2.2 times the PL peak intensity of the sample obtained by sintering the second mixture to which LiF and the like was not added.

Even if the sintering temperature was 1200° C. or 1400° C., when the concentration of LiF in the third mixture was 0.5% by mass, the PL peak intensity was the highest. The PL peak intensity when the concentration of LiF was 1.0% by mass or less was higher than the PL peak intensity when the concentration of LiF was higher than 1.0% by mass. From these experiment results, it can be seen that when the concentration of LiF in the third mixture is 0.25% by mass or more and 1.0% by mass or less, more preferably 0.75% by mass or less, the intensity of ultraviolet light output from the light emitter can be effectively increased. Even when an alkali metal halide other than LiF, for example, NaF or KF is mixed with the second mixture, it is expected that the result is the same.

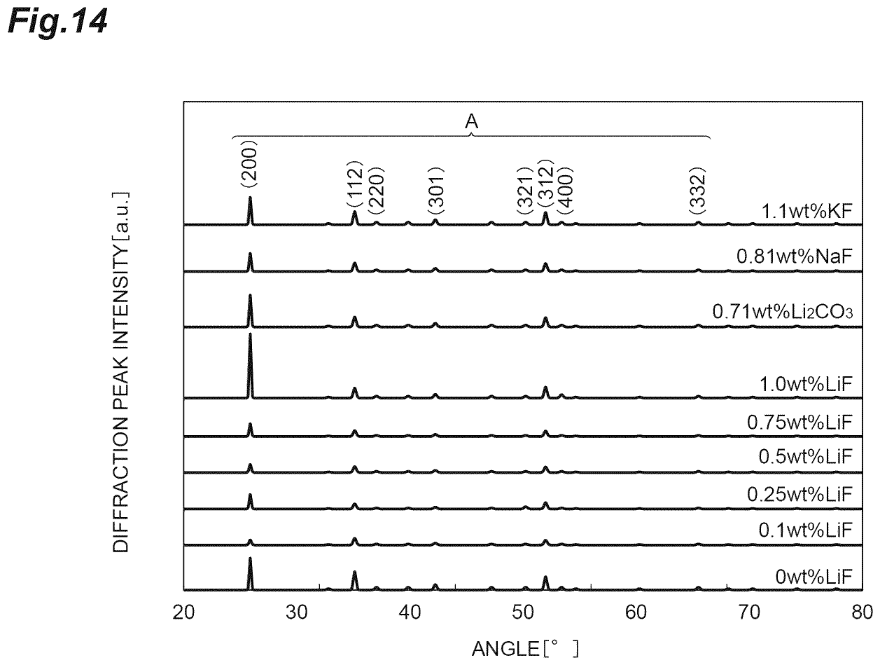

In order to check crystallinity of each sample sintered at 1600° C., X-ray diffraction measurement using a CuKα ray was performed. FIG. 14 is a graph showing an X-ray diffraction pattern of each sample. In the graph, an alkali metal halide or alkali metal carbonate mixed in the sample the concentration thereof corresponding to each diffraction intensity waveform are written. A plurality of numerical values A written in the graph represent crystal plane orientations corresponding to PL peaks of the diffraction intensity waveforms. As shown in FIG. 14, X-ray diffraction patterns of Sc:YPO₄ and Sc:YPO₄ to which LiF, Li₂CO₃, NaF, or KF was added were consistent with an X-ray diffraction pattern of YPO₄ with a tetragonal xenotime structure described in 01-084-0335 of an inorganic crystal structure database (ICSD) of The Japan Association for International Chemical Information. From this result, it can be seen that even when LiF, Li₂CO₃, NaF, or KF is added, crystallinity of YPO₄ is not impaired.

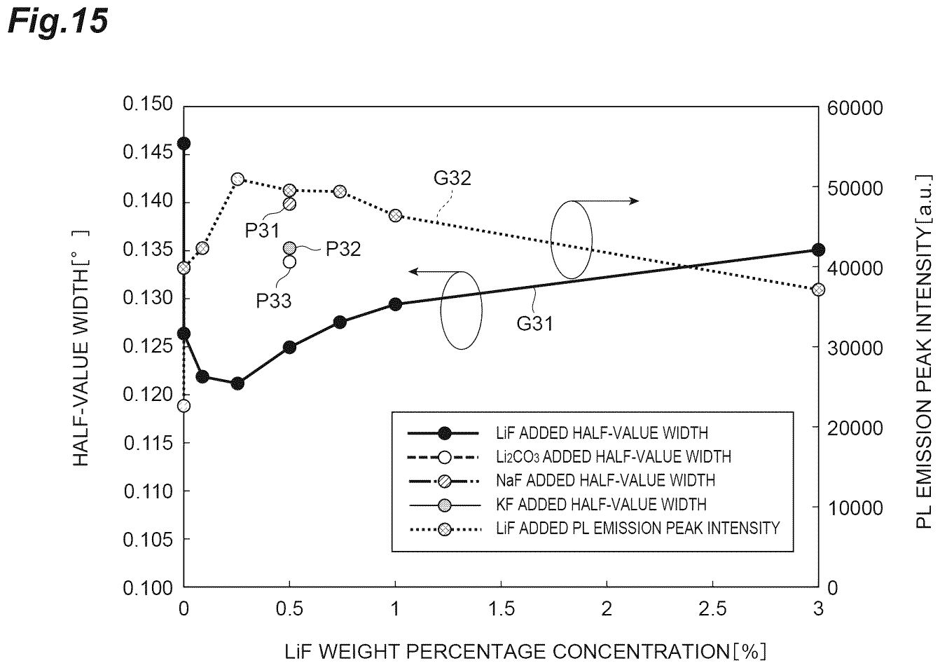

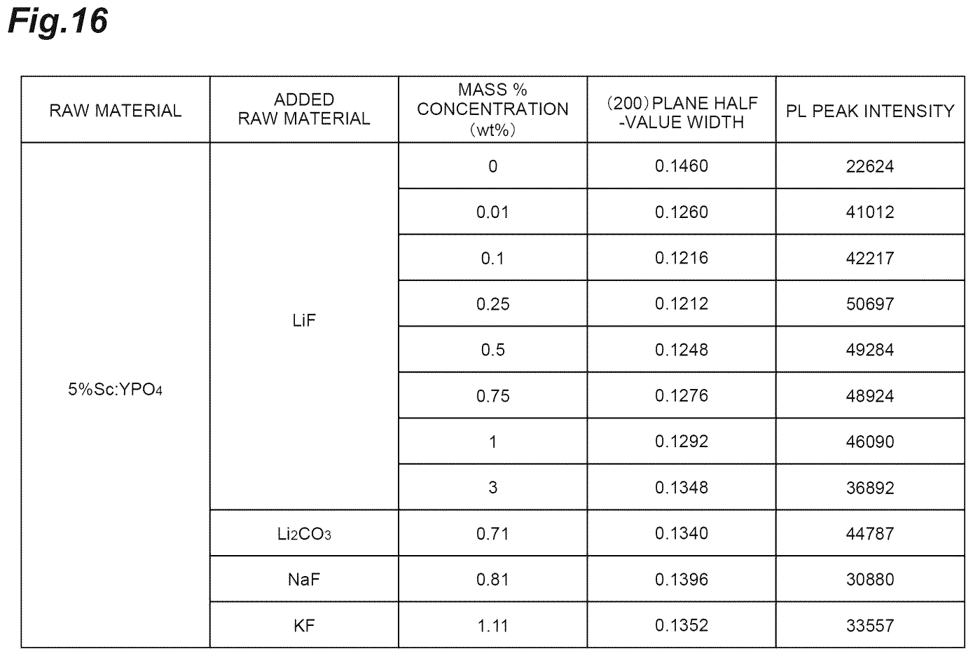

FIG. 15 is a polygonal line graph including lines G31 and G32. The line G31 shows a relationship between weight percentage concentration of LiF in the third mixture and half-value width (unit: degrees and left vertical axis) of a (200) plane PL peak near 26 degrees of an X-ray diffraction pattern in the sample obtained by sintering the third mixture at a sintering temperature of 1600° C. The line G32 shows a relationship between weight percentage concentration of LiF in the third mixture and PL peak intensity (arbitrary unit and right vertical axis) in the sample obtained by sintering the third mixture at a sintering temperature of 1600° C. In FIG. 15, half-value widths of (200) plane PL peaks near 26 degrees of X-ray diffraction patterns in the samples (sintering temperature: 1600° C.) to each of which NaF, KF, or Li₂CO₃ is added are shown as plots P31 to P33. FIG. 16 is a table showing the half-value widths of the (200) plane PL peaks and actual measured values of the PL peak intensities shown in FIG. 15.

Referring to the line G31 of FIG. 15, when the concentration of LiF was 0% by mass, namely, LiF was not added, the half-value width of the (200) plane PL peak was 0.1460°. When the concentration of LiF was 0.25% by mass, the half-value width of the (200) plane PL peak was 0.1212° that was a minimum value, and the best crystallinity was obtained. In addition, when the concentration of LiF further increased, the half-value width of the (200) plane PL peak increased, and crystallinity decreased.

When the line G31 is compared to the line G32, it can be seen that in the range of the weight percentage concentration of LiF from 0% by mass to 0.25% by mass, the half-value width gradually decreases with an increase in the weight percentage concentration of LiF, and accordingly, the PL peak intensity gradually increases. It can be seen that in the range of the weight percentage concentration of LiF that is greater than 0.25% by mass, the half-value width gradually increases with an increase in the weight percentage concentration of LiF, and accordingly, the PL peak intensity gradually decreases. From this result, it can be seen that in Sc:YPO₄ to which LiF is added, there is a significant correlation between the half-value width of the (200) plane PL peak and the PL peak intensity.

Referring to FIG. 16, when LiF, NaF, KF, or Li₂CO₃ was added, the half-value width of the (200) plane PL peak was 0.140° or less. It can be seen that the half-value width is less than the half-value width of the (200) plane PL peak when none of LiF, NaF, KF, and Li₂CO₃ is added, namely, less than 0.146°, and crystallinity when LiF, NaF, KF, or Li₂CO₃ is added is improved. Particularly, when LiF was added in a weight percentage concentration of 0.01% by mass or more and 1.0% by mass or less, the half-value width of the (200) plane PL peak was 0.130° or less, and crystallinity was remarkably improved.

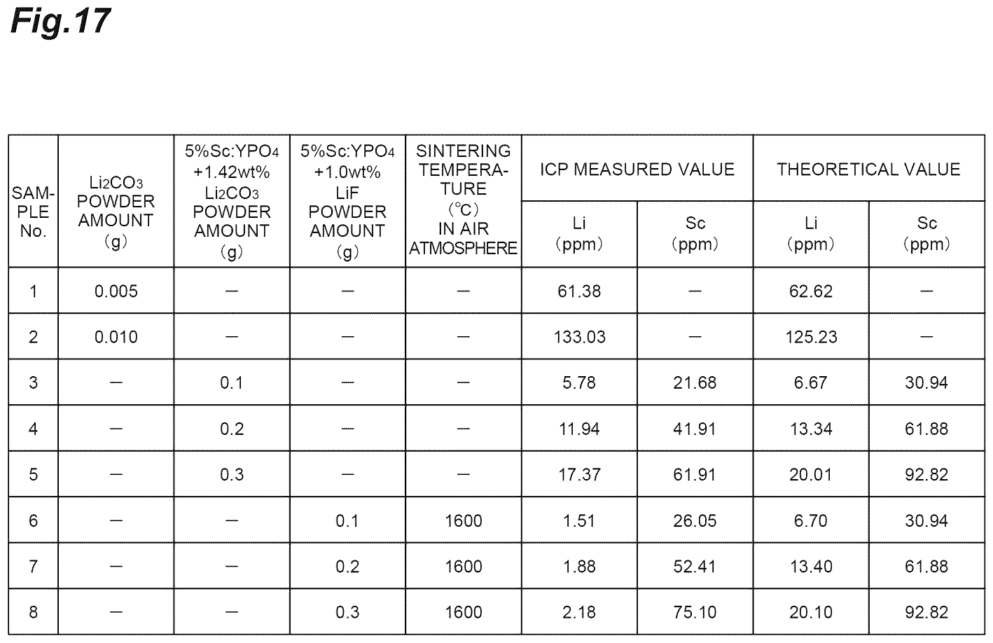

FIG. 17 is a table showing results of high-frequency inductively coupled plasma atomic emission spectroscopy (ICP-AES) performed to check an amount of Li contained in Sc:YPO₄ crystals after sintering. Sample numbers 1 and 2 in the table show analysis results of Li₂CO₃ that is not sintered. Sample numbers 3 to 5 show analysis results of Sc:YPO₄ crystals to which 1.42% by mass of Li₂CO₃ is added and which are not sintered. Sample numbers 6 to 8 show analysis results of Sc:YPO₄ crystals that are sintered with 1.0% by mass of LiF added. As shown in FIG. 17, in Li₂CO₃ that was not sintered (No. 1 and No. 2) and in the Sc:YPO₄ crystals to which Li₂CO₃ was added and which was not sintered (No. 3 to No. 5), Li and Sc were detected in amounts close to theoretical values, namely, charge-in amounts. On the other hand, in the Sc:YPO₄ crystals that was sintered with LiF added (No. 6 to No. 8), the amounts of Li were smaller than a theoretical value, but a significant amount of Li and Sc were detected. From these results, it can be seen that in the Sc:YPO₄ crystals that are sintered with LiF added, the amount of Li is reduced by sintering, but unlike a case where a small amount of Li that is not completely removed after being used as a flux remains, a large amount of Li is contained significantly, namely, as one component. Even in Sc:YPO₄ crystals that are sintered with an alkali metal halide other than LiF, for example, NaF or KF added, it is expected that the result is same.

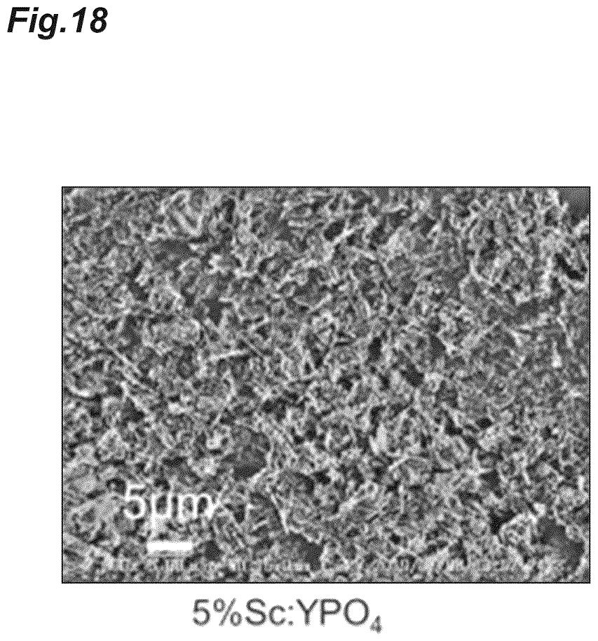

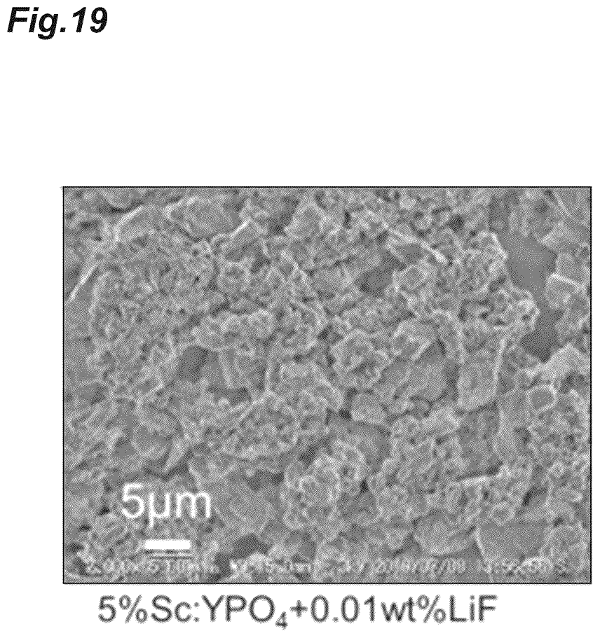

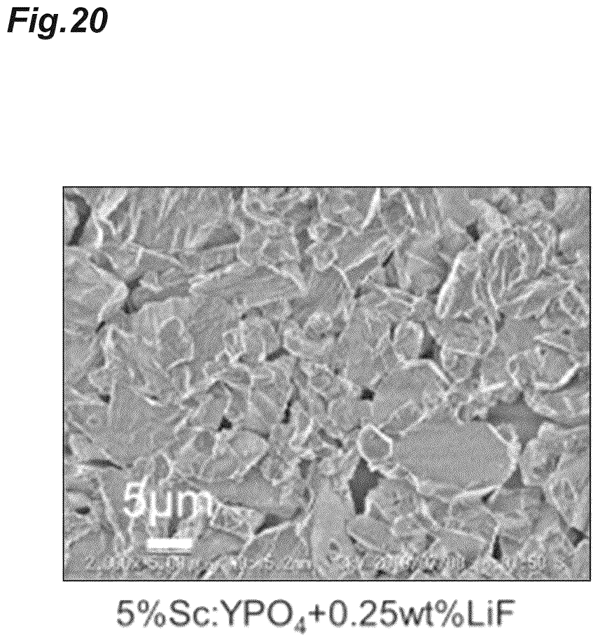

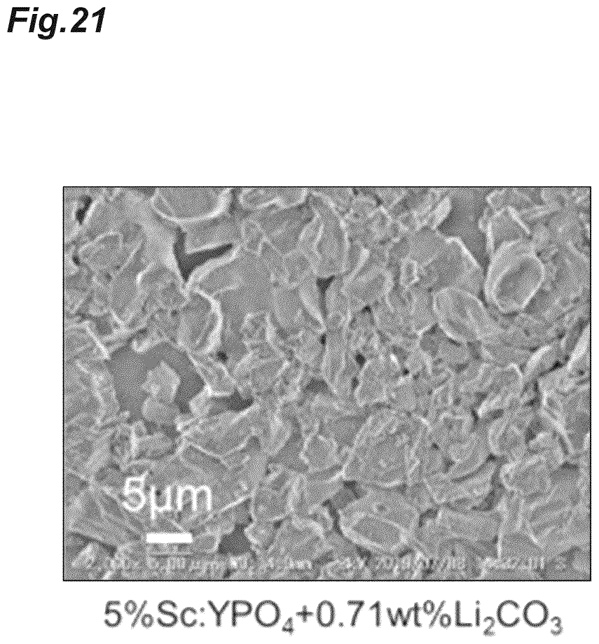

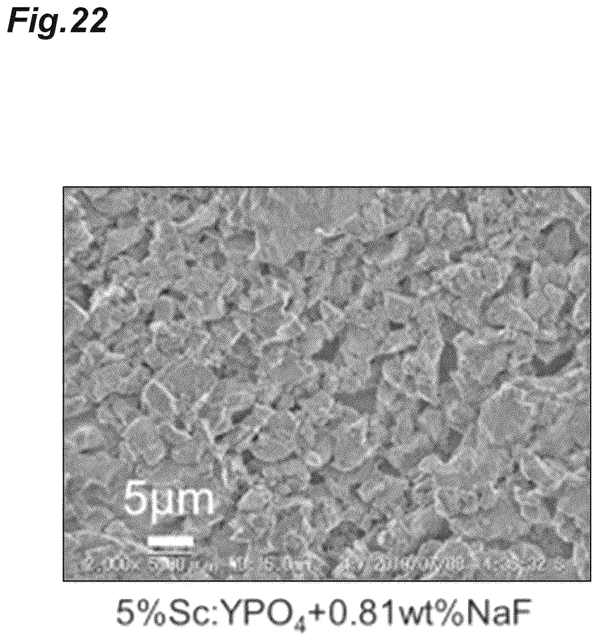

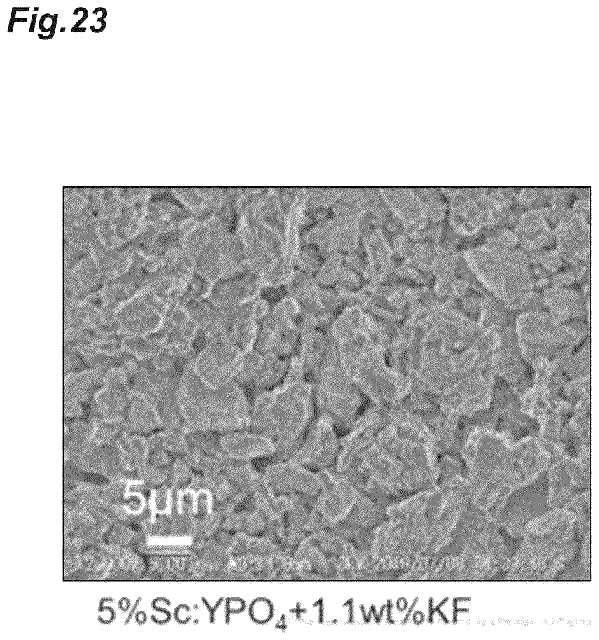

FIGS. 18 to 23 are views showing scanning electron microscope (SEM) photographs of observed powder surfaces of each of the samples produced in the present examples. FIG. 18 shows Sc:YPO₄ crystals obtained by sintering a mixture not containing LiF or the like. FIG. 19 shows Sc:YPO₄ crystals obtained by sintering a mixture containing 0.01% by mass of LiF. FIG. 20 shows Sc:YPO₄ crystals obtained by sintering a mixture containing 0.25% by mass of LiF. FIG. 21 shows Sc:YPO₄ crystals obtained by sintering a mixture containing 0.71% by mass of Li₂CO₃. FIG. 22 shows Sc:YPO₄ crystals obtained by sintering a mixture containing 0.81% by mass of NaF. FIG. 23 shows Sc:YPO₄ crystals obtained by sintering a mixture containing 1.1% by mass of KF.

Referring to FIGS. 18 to 23, it can be seen that the Sc:YPO₄ crystals obtained by sintering a mixture not containing LiF or the like (FIG. 18) have a fine needle structure, but the structures of the other Sc:YPO₄ crystals (FIGS. 19 to 23) are changed from a needle structure to a large agglomerate structure having smooth surfaces and an outer diameter of approximately 5 μm to 20 μm by adding LiF, Li₂CO₃, NaF, or KF before sintering. In addition, it is expected that the PL peak intensity is improved by this change. As described above, in the Sc:YPO₄ crystals to which 0.25% by mass of LiF was added (FIG. 20), the PL peak intensity was the largest.

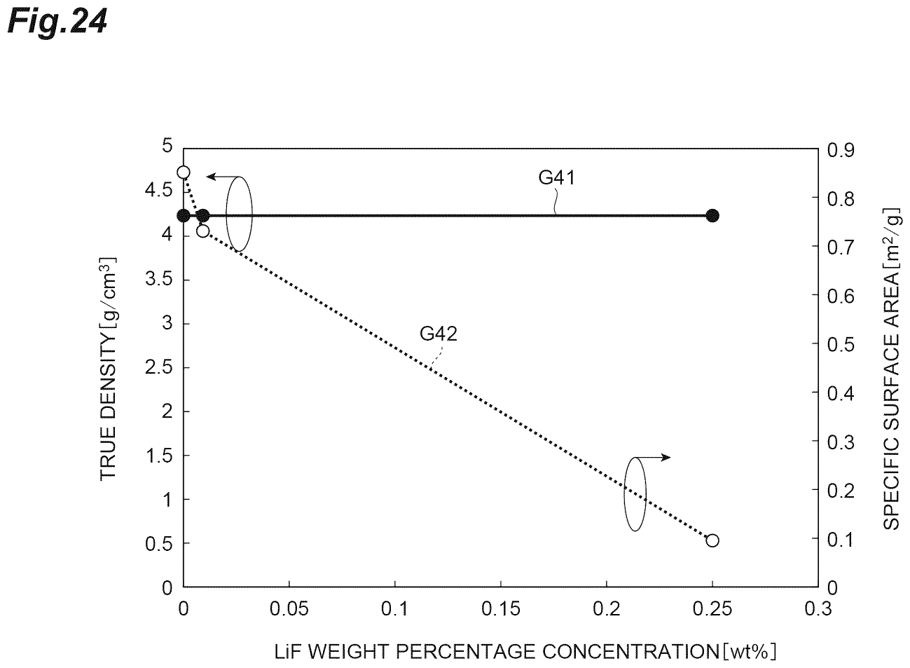

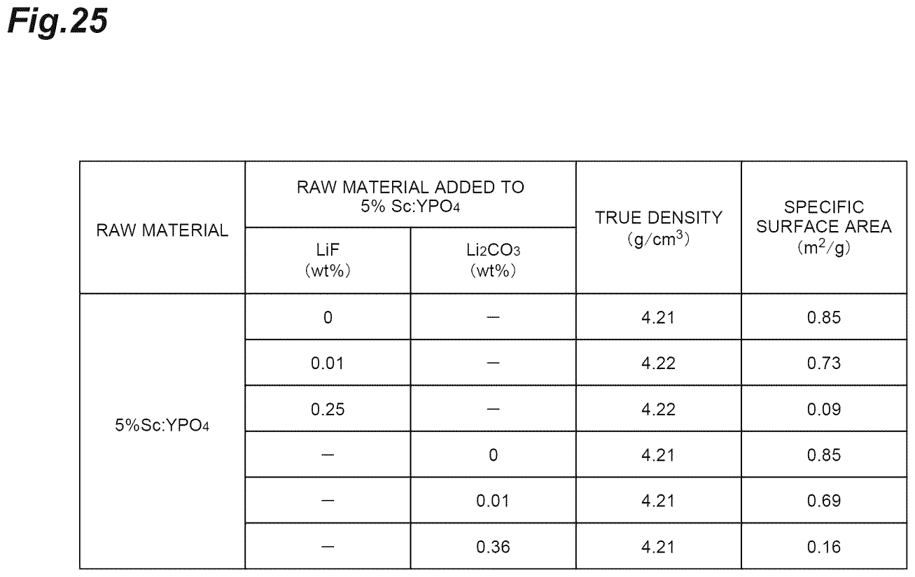

FIG. 24 is a polygonal line graph including lines G41 and G42. The line G41 shows a relationship between mass percentage concentration of LiF in the third mixture and true density (unit: g/cm³ and left vertical axis) of crystals in the sample obtained by sintering the third mixture at a sintering temperature of 1600° C. The line G42 shows a relationship between weight percentage concentration of LiF in the third mixture and specific surface area (unit: m²/g and right vertical axis) in the sample obtained by sintering the third mixture at a sintering temperature of 1600° C. FIG. 25 is a table showing values of the true density and the specific surface area shown in FIG. 24.

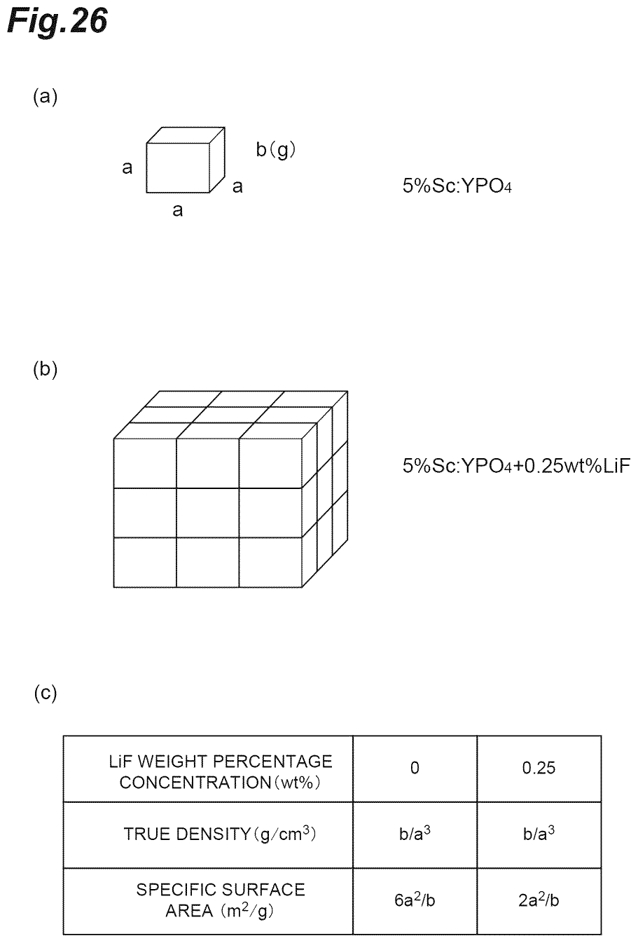

Here, the true density refers to a volume occupied by a substance itself and excluding pores and internal voids in the substance. FIG. 26 is a view conceptually showing true densities and specific surface areas in the Sc:YPO₄ crystals obtained by sintering a mixture not containing LiF or the like (mass percentage concentration of LiF=0) and in the Sc:YPO₄ crystals obtained by sintering a mixture containing LiF (mass percentage concentration of LiF=0.25). Since the Sc:YPO₄ crystals obtained by sintering a mixture not containing LiF or the like have a fine needle structure, as shown in part (a) of FIG. 26, the Sc:YPO₄ crystals are modeled as a cube with one side having a length of a. When the mass of the cube is b, as shown in part (c) of FIG. 26, the true density of the crystals is calculated as b/a³, and the specific surface area is calculated as 6a²/b. On the other hand, the Sc: YPO₄ crystals obtained by sintering a mixture containing LiF have a large agglomerate structure. When it is assumed that the outer diameter of the agglomerate structure is 3 times the outer diameter of the needle structure, as shown in part (b) of FIG. 26, the Sc:YPO₄ crystals obtained by sintering a mixture containing LiF are modeled as a cube with one side having a length of 3a. Similarly to part (a) of FIG. 26, when the mass of the cube with one side having a length of a is b, as shown in part (c) of FIG. 26, the true density of the crystals is calculated as b/a³, and the specific surface area is calculated as 2a²/b.

The true density shown in FIGS. 24 and 25 was a substantially constant value of 4.21 g/cm³ to 4.22 g/cm³ regardless of the concentration of LiF. On the other hand, the specific surface area gradually decreased from 0.85 m²/g to 0.73 m²/g and then to 0.09 m²/g as the concentration of LiF increased. In addition, when the specific surface area was 0.09 m²/g, the PL peak intensity was the largest.

As described above, the crystal size is increased by sintering the Sc:YPO₄ crystals with an alkali metal halide such as LiF, NaF, or KF and an alkali metal carbonate such as Li₂CO₃ added. This is considered to be one of the reasons why the PL peak intensity is increased.

The method for manufacturing a light emitter, the light emitter, and the ultraviolet light source according to the present disclosure are not limited to the above-described embodiment, and can be modified in other various modes. For example, in the embodiment, the excimer lamp has been provided as an example of the light source that irradiates the light emitter with excitation light, but the light source is not limited thereto, and other various light-emitting devices capable of outputting excitation light can be used. In the examples, Sc:YPO₄ crystals not containing an activator other than Sc have been provided as an example, but in addition to Sc, even when an activator such as Bi other than Sc is further contained, it is expected that the same results are obtained.

### REFERENCE SIGNS LIST

10, 10A to 10C: ultraviolet light source, 11: envelope, 12: electron source, 13: extraction electrode, 16: power supply unit, 20: ultraviolet light generation target, 21: substrate, 21a: main surface, 21b: back surface, 22: light emitter, 24: light reflection film, 31A, 31B: envelope, 31a: outer cylindrical portion, 31b: inner cylindrical portion, 32A, 32B, 32C, 33A, 33B, 33C: electrode, 34: light emitter, 35A, 35B: internal space, 40: device, 42: ultraviolet light source, 44: quartz substrate, 45: sample, 46: optical fiber, 47: spectral detector, 48: computer, EB: electron beam, UV: ultraviolet light.

1. A method for manufacturing a light emitter that generates ultraviolet light, wherein the light emitter contains a YPO₄ crystal to which at least scandium (Sc) is added, and receives an electron beam or excitation light which has a shorter wavelength than a wavelength of the ultraviolet light, to generate the ultraviolet light, the method including:
producing a first mixture containing a compound of yttrium (Y), a compound of scandium (Sc), phosphoric acid or a phosphate compound, and a liquid;
producing a second mixture in a powder form by evaporating the liquid;
producing a third mixture by mixing either one or both of an alkali metal halide and an alkali metal carbonate with the second mixture; and
sintering the third mixture.

2. The method for manufacturing a light emitter according to claim 1,
wherein the alkali metal halide is at least one of LiF, NaF, and KF.

3. The method for manufacturing a light emitter according to claim 1,
wherein the alkali metal carbonate is Li₂CO₃.

4. The method for manufacturing a light emitter according to claim 1,
wherein a concentration of the alkali metal halide in the third mixture before sintering is 0.25% by mass or more and 1.0% by mass or less.

5. The method for manufacturing a light emitter according to claim 4,
wherein the concentration of the alkali metal halide in the third mixture before sintering is 0.75% by mass or less.

6. The method for manufacturing a light emitter according to claim 1,
wherein a sintering temperature in the sintering the third mixture is 1200° C. or higher.

7. The method for manufacturing a light emitter according to claim 6,
wherein the sintering temperature is 1400° C. or higher.

8. The method for manufacturing a light emitter according to claim 6,
wherein the sintering temperature is 1600° C. or higher.

9. A light emitter that generates ultraviolet light,
wherein the light emitter contains a YPO₄ crystal to which at least scandium (Sc) and an alkali metal are added, and receives an electron beam or excitation light which has a shorter wavelength than a wavelength of the ultraviolet light, to generate the ultraviolet light.

10. The light emitter according to claim 9,
wherein a half-value width of a diffraction intensity peak waveform of a <200> plane measured by an X-ray diffractometer using a CuKα ray is 0.140 or less.

11. The light emitter according to claim 9,
wherein the alkali metal is at least one of Li, Na, and K.

12. An ultraviolet light source comprising:
the light emitter according to claim 9; and
a light source that irradiates the light emitter with the excitation light.

13. An ultraviolet light source comprising:
the light emitter according to claim 9; and
an electron source that irradiates the light emitter with the electron beam.
